(19) United States
(12) Patent Application Publication
(10) Pub. No.: US 2006/0174656 A1
(43) Pub. Date: Aug. 10, 2006

(54) Glassware forming machine with bladder-operated cooling wind valve

(75) Inventor: Robin L. Flynn, Waterville, OH (US)

Correspondence Address: OWENS-ILLINOIS, INC., ONE SEAGATE, 25-LDP, TOLEDO, OH, 43666, US

(73) Assignee: Owens-Brockway Glass Container Inc.

(21) Appl. No.: 11/054,141

(22) Filed: Feb. 8, 2005

(51) Int. Cl. C03B 9/38; C03B 11/12

(52) U.S. Cl. 65/356

(57) ABSTRACT

A glassware forming machine includes at least one operating element for forming molten glass gobs into articles of glassware, a source of wind for cooling the operating element, and a system for controlling flow of the cooling wind. The system includes a shut-off valve having a valve body with an air flow passage and an expansible air bladder mounted within the passage. A control valve selectively feeds air under pressure into the expansible bladder to expand the bladder and block the passage. In the preferred embodiment, the bladder is mounted on an arm that is cantilevered from one end of the valve body, and a mounting/transition plate removably mounts the opposing end of the valve body on the glassware forming machine. The mounting/transition plate preferably is of a material of lower thermal conductivity than the valve body to retard heat transfer to the valve body and the bladder.

The present disclosure is directed to glassware forming machines, and more particularly to a valve for selectively controlling flow of cooling wind to operating elements of the glassware forming machine.

### BACKGROUND AND SUMMARY OF THE INVENTIONS

Glassware forming machines include a number of operating mechanisms or elements that form molten glass gobs into articles of glassware. Individual section glassware forming machines include a plurality of identical machine sections operating out of phase with each other. Each section includes a plurality of glassware forming elements, such as blank molds and blow molds, mounted on a section box that is internally pressurized with air. One or more shut-off valves are suspended within the section box for controlling application of the air, termed “cooling wind,” from within the section box to various operating elements of the machine section. For example, U.S. application Ser. No. 10/892,677, filed Jul. 15, 2004, discloses a glassware forming machine having an air-operated or solenoid-operated shut-off valve suspended within each machine section box for controlling application of cooling wind to the machine neck rings. JP 06-064931 (1994) discloses a glassware forming machine having a shut-off valve suspended within the section box for controlling application of cooling wind to the section blow molds. A general object of the present disclosure is to provide a glassware forming machine having a cooling wind shut-off valve of reduced cost and complexity, and having a reduced number of moving parts.

The present disclosure involves a number of aspects or inventions, which may be implemented separately from or in combination with each other.

A glassware forming machine in accordance with one aspect of the present disclosure includes at least one operating element for forming molten glass gobs into articles of glassware, a source of wind for cooling the operating element, and a system for controlling flow of the cooling wind. The system includes a shut-off valve having a valve body with an air flow passage and an expansible air bladder mounted within the passage. A control valve selectively feeds air under pressure into the expansible bladder to expand the bladder and block the passage. In the preferred embodiments of the disclosure, the bladder is mounted on an arm that is cantilevered from one end of the valve body, and a mounting/transition plate removably mounts the opposing end of the valve body on the glassware forming machine. The mounting/transition plate preferably is of a material having lower thermal conductivity than the valve body to retard heat transfer to the valve body and the bladder.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is a sectioned fragmentary elevational view of a glassware forming machine in accordance with one embodiment of the present disclosure;

FIG. 2 is a bottom perspective view of the cooling wind shut-off valve in the machine of FIG. 1;

FIG. 3 is a top perspective view of the cooling wind shut-off valve in FIG. 2; and

FIG. 4 is a fragmentary sectional view that is similar to that of FIG. 1 but shows the valve in the shut-off position.

### DETAILED DESCRIPTION OF PREFERRED EMBODIMENTS

The disclosure of above-noted U.S. application Ser. No. 10/892,677 is incorporated herein by reference.

FIG. 1 is a fragmentary sectional view of an individual section glassware forming machine 10 in accordance with one presently preferred embodiment of the disclosure. Machine 10 includes a section box 12 having a top wall or panel 14 with an opening 16. A shut-off valve 18 is suspended from top wall 14 within section box 12 in alignment with opening 16 for controlling flow of cooling wind in the direction 20 from the interior of section box 12 through suitable conduits or passages (not shown) to one or more operating elements of the glassware forming machine.

Shut-off valve 18 includes a transition plate 22 mounted, as by bolts 24, beneath section box wall 14. A valve body 26 is suspended by screws 27 (FIGS. 2 and 3) beneath mounting/transition plate 22. Valve body 26 defines an internal passage 28, preferably having a substantially cylindrical interior wall surface, that communicates through an opening 29 in plate 22 with air delivery opening 16 in wall 14. An arm 30 is cantilevered from the end of valve body 26 remote from plate 22, preferably by being formed integrally with the valve body. An air-operated valve element 32 is mounted on arm 30 and centrally disposed within air passage 28 of valve body 26.

Valve element 32 preferably includes a central body 34 having a T-shaped air passage 36 that communicates with an air passage 38 that extends through arm 30 and valve body 26. Passage 38 communicates through a passage 40 in mounting/transition plate 22 with a control air opening 42 in section box wall 14. Resilient O-rings 44, 46, 48 or other suitable sealing means are provided between the abutting surfaces of body 34 and arm 30, valve body 26 and transition plate 22, and plate 22 and wall 14 respectively. An air bladder 50 is mounted by clamp rings 52, 54 on the exterior of body 34 so that air passage 36 communicates with the sealed interior of the bladder. Bladder 50 may be of reinforced rubber or other suitable flexible resilient composition. A nose cone 56 preferably is mounted on the end of body 34 remote from arm 30, and is generally centrally positioned within air passages 28,29. One suitable valve element 32 is marketed by Firestone under the trade designation “AirPicker.”

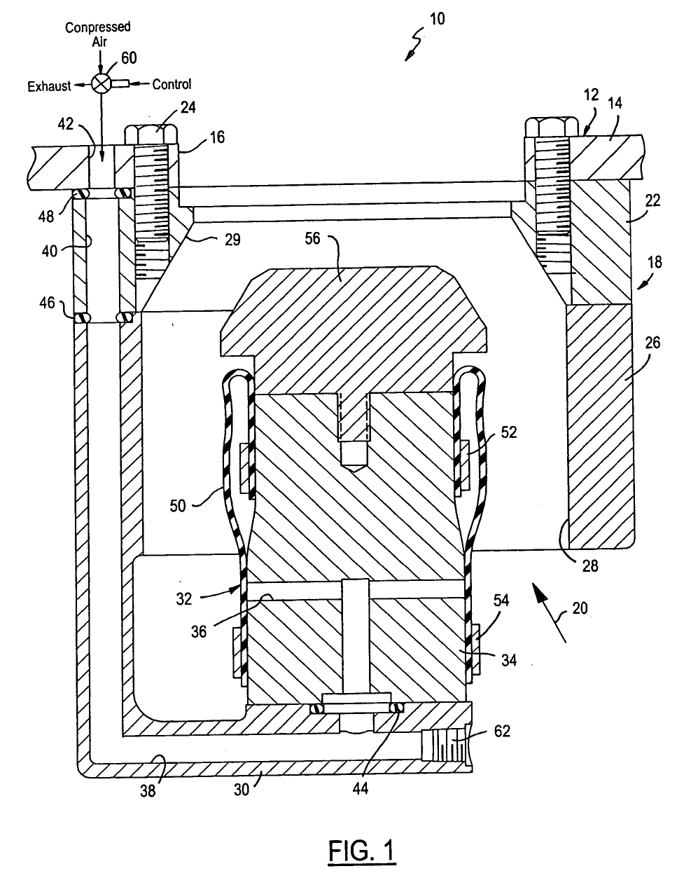

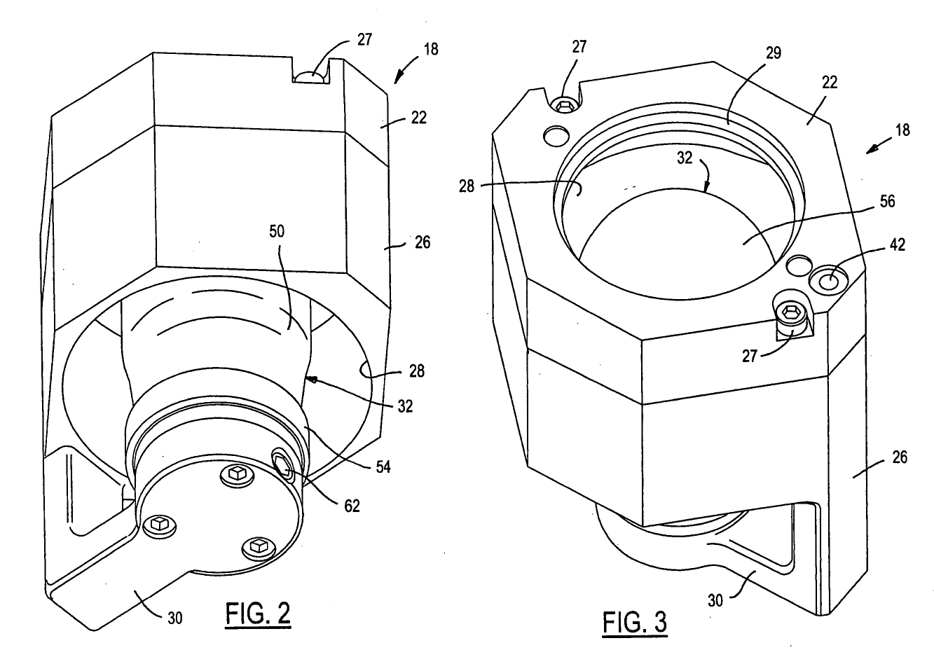

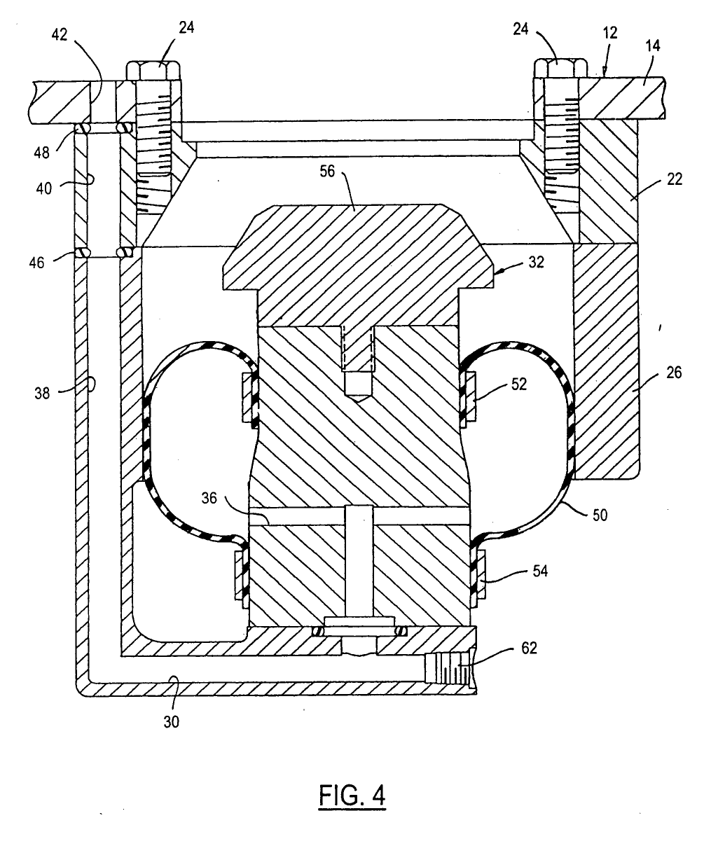

A control vale 60, which may be a pneumatic control valve or an electrical solenoid-operated control valve, receives control signals from a suitable source, such as an electronic controller, and selectively feeds compressed air to or exhausts air from opening 42 in section box wall 14. This air is fed through passages 40, 38 and 36 to the interior of bladder 50, selectively to expand the bladder from the relaxed or open position of FIG. 1 to the expanded or closed position of FIG. 4. In the position of FIG. 1, cooling wind from the interior of section box 12 freely flows in the direction 20 through passages 28,29 and opening 16 to the elements of the glassware forming machine to be cooled. However, in the expanded closed position of FIG. 4, such flow of cooling wind is blocked. When cooling wind flow again is desired, valve 60 is placed in the exhaust position and the resiliency of bladder 50 exhausts the air through valve 60.

As noted above, the interior surface of passage 28 in valve body 26 preferably is substantially cylindrical, and valve element 32 preferably is centrally positioned within valve body 26 so that bladder 50 is uniformly expanded against the interior surface of the valve body in the position of FIG. 4. Removal of control air by closure of valve 60 allows the resilient elasticity of bladder 50 to relax the bladder to the position of FIG. 1 and allow free flow of cooling wind. A plug 62 preferably is received in the end of passage 38 in arm 30. It will be appreciated, of course, that control air could as effectively be applied to bladder 50 through the opening in arm 30 that preferably is closed by plug 62. Mounting/transition plate 22 is removably mounted on valve body 26 and may readily be configured for differing applications. Furthermore, mounting/transition plate 22 preferably is of a material having lower thermal conductivity than valve body 26 so as to retard heat transfer from section box wall 14 to valve body 28 and bladder 50 of valve element 32.

There thus has been disclosed a glassware forming machine with cooling wind shut-off valve that fully satisfies all of the objects and aims previously set forth. For example, shut-off valve 18 has only one moving part—i.e., expansible/contractible flexible resilient air bladder 32—as distinguished from the multiple moving parts that are characteristic of the prior art. The disclosure has been presented in conjunction with a presently preferred embodiment thereof, and a number of modifications and variations have been discussed. Other modifications and variations readily will suggest themselves to persons of ordinary skill in the art in view of the foregoing disclosure. The disclosure is intended to embrace all such modifications and variations as fall within the spirit and broad scope of the appended claims.

1. A glassware forming machine that includes at least one operating element for forming molten glass gobs into articles of glassware, a source of wind for cooling said at least one operating element, and a system for controlling flow of cooling wind, which includes:
a shut-off valve having a valve body with an air flow passage and an expansible air bladder mounted within said passage, and a control valve for selectively feeding air into said expansible bladder to expand said bladder and block said passage.

2. The machine set forth in claim 1 wherein said air flow passage in said valve body is cylindrical, and wherein said bladder is mounted within said passage and expands radially outwardly to block said passage.

3. The machine set forth in claim 2 including a nose cone in fixed position on said shut-off valve for guiding air flow through said passage.

4. The machine set forth in claim 1 wherein said bladder is mounted on an arm cantilevered from said valve body.

5. The machine set forth in claim 1 including a mounting/transition plate at an end of said valve body remote from said arm and removably mounting said valve body in position in the glassware forming machine.

6. The machine set forth in claim 5 wherein said mounting/transition plate is of a material of lower thermal conductivity than said valve body to retard heat transfer to said valve body and said bladder.

7. A glassware forming machine that includes at least one operating element for forming molten glass gobs into articles of glassware, a section box on which said at least one operating element is mounted and being internally pressurized with cooling wind, and a shut-off valve suspended within said section box for controlling flow of cooling wind from within said section box to said at least one operating element,
said shut-off valve having a valve body with an air flow passage and being suspended within said section box, and an expansible air bladder mounted by said valve body within said passage and being radially outwardly expansible to block flow of cooling wind from within said section box.

8. The machine set forth in claim 7 including a mounting/transition plate removably mounted on said valve body and suspending said valve body within said section box.

9. The machine set forth in claim 8 wherein said mounting/transition plate is of a material of lower thermal conductivity than said valve body to retard heat transfer from said section box to said valve body and said bladder.

10. The machine set forth in claim 9 wherein said bladder is mounted on an arm cantilevered from an end of said valve body remote from said mounting/transition plate.

11. The machine set forth in claim 7 including a nose cone in fixed position on said shut-off valve for guiding flow of cooling wind through said air flow passage.
